(19) United States
(12) Patent Application Publication
(10) Pub. No.: US 2025/0175931 A1
(43) Pub. Date: May 29, 2025

(54) SYSTEMS AND METHODS FOR POSITIOINING ACCURACY IMPROVEMENT FOR LOW-CAPABILITY USER EQUIPMENT

(71) Applicant: ZTE Corporation, Shenzhen (CN)

(72) Inventors: Focai PENG, Shenzhen (CN); Chuangxin JIANG, Shenzhen (CN); Mengzhen LI, Shenzhen (CN); Cong WANG, Shenzhen (CN); Juan LIU, Shenzhen (CN); Qi YANG, Shenzhen (CN); Di ZONG, Shenzhen (CN)

(73) Assignee: ZTE Corporation, Shenzhen (CN)

(21) Appl. No.: 18/769,053

(22) Filed: Jul. 10, 2024

Related U.S. Application Data
(63) Continuation of application No. PCT/CN2022/129603, filed on Nov. 3, 2022.

(51) Int. Cl. H04W 64/00; H04L 5/00; H04W 24/10

(52) U.S. Cl. CPC H04W 64/00; H04L 5/0012; H04L 5/0051; H04W 24/10

(57) ABSTRACT

Presented are systems and methods for positioning. A user equipment (UE) can receive configuration information of a reference signal for positioning from a network. The configuration information can comprise information associated with frequency hopping of the reference signal. The UE can receive the reference signal. The UE can measure the reference signal. The UE can send a report comprising a measurement result of the reference signal to the network.

### CROSS-REFERENCE TO RELATED APPLICATION

This application claims the benefit of priority under 35 U.S.C. § 120 as a continuation of PCT Patent Application No. PCT/CN2022/129603, filed on Nov. 3, 2022, the disclosure of which is incorporated herein by reference in its entirety.

### TECHNICAL FIELD

The disclosure relates generally to wireless communications, including but not limited to systems and methods for positioning accuracy improvement for low-capability user equipment (UE).

### BACKGROUND

A location server is a physical or logical entity that can collect measurements and other location information from the device and base station, and can utilize the measurements and estimate characteristics such as its position. The location server can process a request from the device and can provide the device with the requested information.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium. A user equipment (UE) can receive configuration information of a reference signal for positioning from a network. The configuration information can comprise information associated with frequency hopping of the reference signal. The UE can receive the reference signal. The UE can measure the reference signal. The UE can send a report to the network. The report can comprise a measurement result of the reference signal.

In some implementations, the report can comprise a phase of a channel in each hop of the frequency hopping and an associated channel figure. In some implementations, the report can comprise a carrier phase difference with respect to a reference carrier. In some implementations, the report can comprise an identification (ID) of each hop of the frequency hopping.

In some implementations, the report can indicate that a first hop of the frequency hopping starts, or restarts, with a specific system frame number. In some implementations, the configuration information can indicate an overlap factor. In some implementations, the configuration information can indicate an overlapped bandwidth.

In some implementations, the configuration information can comprise a number of Resource Blocks (RBs) configured for transmitting the reference signal. The number can be equal to m_{SRS,b}+NumberOfOverlappedRB. The m_{SRS,b} can be configured by a first higher layer for transmitting the reference signal and the NumberOfOverlappedRB can be configured by a second higher layer for transmitting the reference signal. In some implementations, the configuration information can comprise a length of the reference signal with frequency-overlapped hopping. The length can be equal to M_{SC,b}^{SRS}+NumberOfOverlappedSC. The M_{SC,b}^{SRS} may be a length of the reference signal with frequency-non-overlapped hopping and the NumberOfOverlappedSC may be a number of overlapped sub-carriers which is configured by a higher layer or the network.

In some implementations, the configuration information can comprise a length of the reference signal with frequency-overlapped hopping. The length can be equal to M_{SC,b}^{SRS}*NumberOfHop. M_{SC,b}^{SRS} may be a sequence length of the reference signal for each hop of the frequency hopping without overlapping and the NumberOfHop may be a number of hops. In some implementations, the configuration information can comprise, for each hop of the frequency hopping, an associated frequency position index n_{b} may be equal to

$${n}_{b} = \{ \begin{matrix}⌊ 4 ( {n}_{R R C} + NumberOfOverlappedRB ) / {m}_{S R S , b} ⌋ mod {N}_{b} & b \leq {b}_{hop} \\ ( {F}_{b} ( {n}_{SRS} ) + ⌊ 4 ( {n}_{R R C} + NumberOfOverlappedRB ) / {m}_{SRS , b} ⌋ ) mod {N}_{b} & otherwise\end{matrix} .$$

n_{RRC}, m_{SRS,b}, N_{b} may each be configured by a higher layer or the network, and the F_{b}(n_{SRS}) may be a value associated with transmission of the reference signal.

In some implementations, the configuration information can comprise, for each hop of the frequency hopping, an associated frequency position index n_{b} may be equal to

$${n}_{b} = \{ \begin{matrix}⌊ 4 ( {n}_{R R C} - NumberOfOverlappedRB ) / {m}_{S R S , b} ⌋ mod {N}_{b} & b \leq {b}_{hop} \\ ( {F}_{b} ( {n}_{SRS} ) + ⌊ 4 ( {n}_{R R C} - NumberOfOverlappedRB ) / {m}_{SRS , b} ⌋ ) mod {N}_{b} & otherwise\end{matrix} .$$

n_{RRC}, m_{SRS,b}, N_{b} may each be configured by a higher layer or the network, and the F_{b}(n_{SRS}) may be a value associated with transmission of the reference signal.

In some implementations, the UE can determine that a frequency position index associated with a hop of the frequency hopping is out of range of a bandwidth part (BWP) but not out of range of a carrier. The UE can continue receiving the reference signal. In some implementations, the configuration information can comprise a generator configured to generate a pseudo-random sequence to generate the reference signal, wherein the generator is initialized based on

$${c}_{i n i t} = ( {2}^{22} ⌊ \frac{{n}_{ID , seq}^{PRS}}{1024} ⌋ + {2}^{10} ( {N}_{symb}^{slot} {n}_{s , f}^{μ} + l + 1 ) ( 2 ( {n}_{ID , seq}^{PRS} mod 1024 ) + 1 ) + ( {n}_{ID , s e q}^{PRS} mod 1024 ) + HopID ) mod {2}^{31} .$$

The n_{s,f}^{μ} may be a slot number, the sequence ID n_{fID,seq}^{PRS} ∈{0, 1, . . . , 4095, 4096, 4097, . . . , 8191} may be configured by a higher layer, the l may be a symbol index within a slot, the N_{symb}^{slot} may be a number of symbols in a slot, the HopID may be a hopping ID of the reference signal.

In some implementations, the configuration information can comprise a total length m of a sequence of all hops of the frequency hopping. m may be equal to NumberOfRB*NumberOfHop. The NumberOfRB may be a number of RB for each of the hops without overlapping, and the NumberOfHop may be a number of the hops. In some implementations, the configuration information can comprise a bandwidth of the reference signal. The bandwidth may be equal to n_{RRC}+NumberOfOverlappedRB. The n_{RRC} may be a bandwidth with non-overlapped transmission, and the NumberOfOverlappedRB may be configured by a high layer.

In some implementations, the configuration information can indicate that a comb size of the reference signal can be configured as one or three. In some implementations, the configuration information can indicate that when the UE is a RedCap UE, a total measurement delay is relaxed with number of hops. In some implementations, the report can comprise a positioning process window (PPW) configured for a RedCap UE may be NormalPPW*NumberOfHop. The NormalPPW may be the PPW for a normal UE.

In some implementations, the report can comprise a number of paths for measurement for a RedCap UE being relaxed. In some implementations, the report can comprise positioning-related information measured based on multiple Synchronization Signal Blocks (SSBs). The report can comprise a capability of the UE to support measurement on multiple SSBs.

At least one aspect is directed to a system, method, apparatus, or a computer-readable medium. A base station (BS) can determine configuration information of a reference signal for positioning. The configuration information can comprise information associated with frequency hopping of the reference signal. The BS can receive the reference signal. The BS can measure the reference signal. The BS can send a report to a network. The report can comprise a measurement result of the reference signal.

In some implementations, the report can comprise measurements on one or more concatenated Sounding Reference Signals (SRSs).

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example of a downlink (DL) signaling for measuring reference signals, in accordance with some embodiments of the present disclosure;

FIG. 4 illustrates an example of an uplink (UL) signaling for measuring reference signals, in accordance with some embodiments of the present disclosure;

FIG. 5 illustrates an example graph of phase estimation error relative to a cumulative distribution function (CDF), in accordance with some embodiments of the present disclosure;

FIG. 6 illustrates an example of identifications/identifiers (IDs) associated with parts of a positioning measurement result(s), in accordance with some embodiments of the present disclosure;

FIG. 7 illustrates an example graph of positioning accuracy relative to a CDF, in accordance with some embodiments of the present disclosure;

FIG. 8 illustrates an example of frequency overlap between two adjacent transmissions of reference signals, in accordance with some embodiments of the present disclosure;

FIG. 9 illustrates an example of a reference signal pattern, in accordance with some embodiments of the present disclosure;

FIG. 10 illustrates an example of a carrier having several bandwidth parts (BWPs), in accordance with some embodiments of the present disclosure; and

FIG. 11 illustrates a flow diagram of an example method for low-capability UE positioning, in accordance with an embodiment of the present disclosure.

### DETAILED DESCRIPTION

### 1. Mobile Communication Technology and Environment

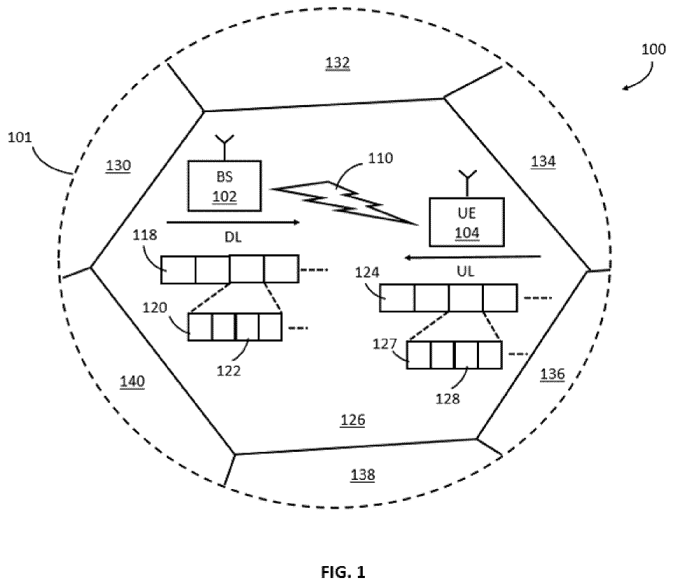

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

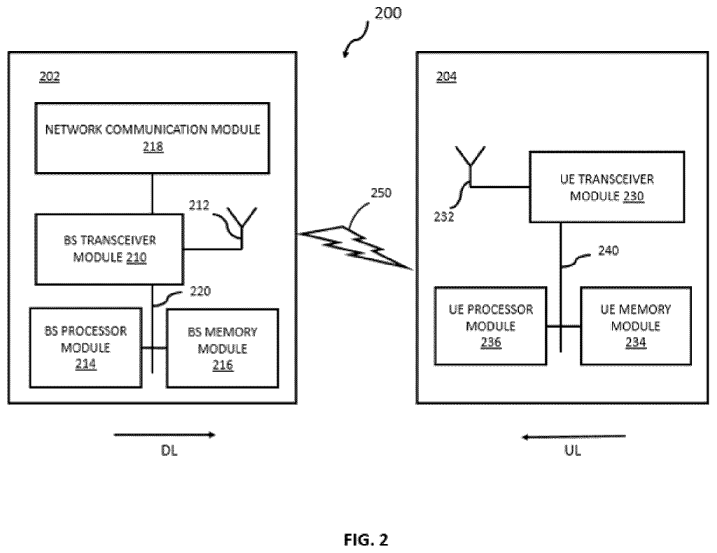

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Positioning Accuracy Improvement for Low-Capability UE

In certain systems, a method of positioning (e.g., positioning measurement or determination) can be provided or performed using positioning reference signal (PRS) (e.g., from a BS 102, gNB, transmission/reception point (TRP), or wireless communication node), and/or sounding reference signal (SRS) (e.g., from the UE 104 or wireless communication device) on a radio side. In some circumstances, certain UEs 104 may have a relatively reduced/lower capability, such as relative to other UEs 104 with higher capability. For instance, these UEs 104 with reduced/low-capability (e.g., referred to herein as reduced-capability (RedCap) UE) may have reception and/or transmission bandwidth limited, capped, or restricted at or under a certain frequency, such as at or under 20 MHz (e.g., in frequency range one (FR1)), 5 MHz (e.g., in 700 MHz band), etc.

Further, the positioning accuracy may be related to the bandwidth of the reference signals (e.g., PRS and/or SRS) used for UE positioning. In some cases, the reduced-capability UE may have a single reception/transmission antenna (e.g., in FR1). In such cases, the accuracy of positioning the reduced-capability UE may be low or reduced compared to other UEs 104 with relatively higher capability (e.g., higher frequency bandwidth, antennas, etc.). Due to the reduced capability, the positioning accuracy of the UEs 104 in certain systems may be lower than desired (e.g., having a positioning accuracy of 3 meters or above). In some instances, environmental factors, such as dense urban areas or obstructions, can further cause the positioning accuracy of the UEs 104 to decrease. With some UEs 104 having reduced capability and certain environmental factors affecting positioning accuracy, it may be difficult to achieve a positioning accuracy of, for instance, less than a predefined distance (e.g., at or under 1 meter). Therefore, the systems and methods of the technical solution discussed herein can provide methods, mechanisms, features, operations, or techniques for improving positioning accuracy for the UE 104, including the reduced-capability UEs.

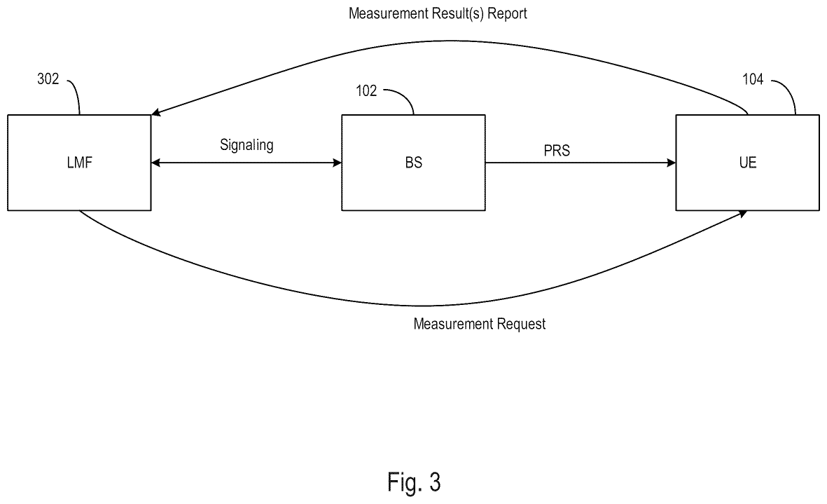

Referring to FIG. 3, depicted is an example of a downlink (DL) signaling 300 for measuring reference signals. In the DL, one or more BSs 102 can transmit/send/communicate/signal/provide the PRS to the UE 104. As discussed herein, the UE 104 may be a reduced-capability UE (e.g., UE 104 with relatively lower capability/support for frequency bandwidth, having a single antenna, etc.). The UE 104 can measure the PRS from the BS 102 or measure PRSs from multiple BSs 102. Subsequently, the UE 104 can report/notify/communicate/send/provide the measurement result(s) of the PRS(s) to a network (e.g., a location management function (LMF) 302 in the core network (CN), etc.). In various arrangements, the network element can include at least one of the BS 102, UE 104, and/or the CN, among others.

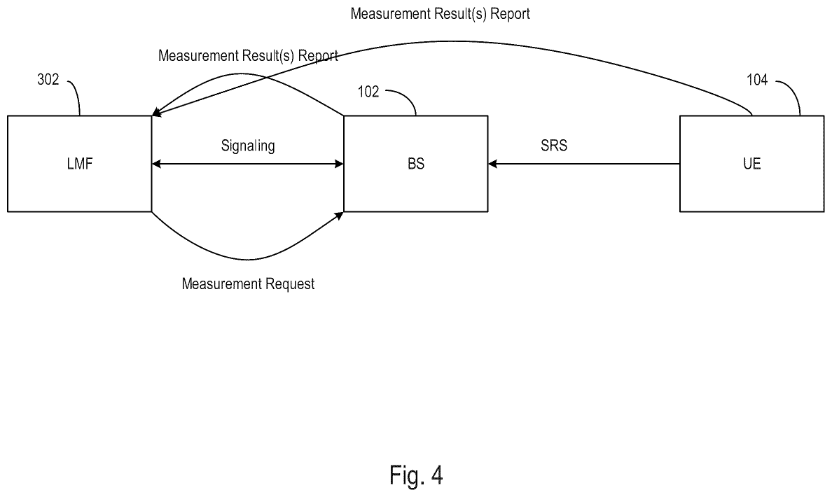

FIG. 4 depicts an example of an uplink (UL) signaling 400 for measuring reference signals. In the UL, the UE 104 can transmit the SRS to one or more BSs 102. The one or more BSs 102 can measure the SRS for the UE 104. Subsequently, the BS 102 can report the measurement result(s) to the network (e.g., LMF 302). In certain cases, the transmission, reception, and/or communication of the PRS and/or SRS for positioning the UE 104 may be affected by the radio propagation environment (e.g., fading, distortion, interference, blockage, etc.), thereby limiting, capping, reducing, or degrading the positioning accuracy.

The systems and methods of the technical solution discussed herein can apply multiple segments (e.g., hops) to the reduced-capability (RedCap) UE(s) (e.g., support limited bandwidth of 20 MHz, 5 MHz, etc., in FR1) for improving the positioning accuracy. In various implementations, the reduced-capability UE can receive/obtain/acquire/collect and/or transmit multiple hops on different frequencies (e.g., at relatively lower bandwidth) and/or different times/instances to form a similar or equivalent high bandwidth (e.g., different frequencies aggregated/cumulated/computed into a high-frequency bandwidth). The systems and methods can avoid/mitigate technical problems/issues related to frequency hopping (e.g., transmission hopping and/or reception hopping), such as random phase at each hop, large time delay, etc.

### Example Implementation 1: Reporting Phase of Channel and/or Channel Figure

In various implementations, after the UE 104 receives the PRS and/or the BS 102 (e.g., gNB or TRP) receives the SRS, the UE 104 and/or the BS 102 (e.g., depending on the recipient or the type of the reference signal) can compute/estimate/measure channel-related information, e.g., phase of the channel, channel impulse response (CIR), and/or channel figure, among others. The channel figure may be associated with the CIR in certain time taps. For instance, for time taps 0 ns, 0.5 ns, and 1 ns, the channel figures may be 1+j, 2+j3, and 4+j5, respectively. In some cases, the channel figure may be a channel frequency response (CFR). For instance, for sub-carriers 0, 1, and 2, the channel figures can be 2−j4, 3−j2, and 7+j8, respectively.

For frequency hopping of PRS/SRS (e.g., non-overlapping in frequency between hops, such as for DL hopping and/or UL hopping), the UE 104 and/or the BS 102 can report the positioning-related information to the network (e.g., LMF 302). The positioning-related information can include at least one of the time of arrival (TOA), time difference of arrival (TDOA), etc. Additionally or alternatively, for frequency hopping of PRS/SRS (e.g., non-overlapping in frequency between hops), the UE 104 and/or the BS 102 can report the positioning-related information with timestamps to the network. In such cases, the computation/processing of the positioning-related information may be performed/loaded/configured on the UE 104 side (e.g., UE reporting for DL).

In various implementations, the network (e.g., LMF 302) can provide the UE 104 and/or the BS 102 with configuration information of the reference signal (e.g., PRS/SRS) for positioning. The configuration information can include information related to or associated with the frequency hopping of the reference signal. The configuration information can be described herein in relation to configuring the frequency hopping, for example.

Additionally or alternatively, when reporting the position-related information, the UE 104 (e.g., reduced-capability UE) may attach/include/provide/indicate a tag, code, or flag in the report indicating that the UE 104 has reduced capability (e.g., “RedCap”, “LowAccuracy”, etc.). The tag can indicate that the positioning accuracy may be low in comparison to other UEs 104 with relatively higher capability/support. In some cases, the tag can indicate that the positioning accuracy criteria, accuracy threshold, or the desired level of accuracy may be lower compared to certain other UEs 104 with relatively higher capability/support. In some cases, the tag can indicate that the uncertainty (e.g., the error margin or inaccuracy) of the positioning for the reduced-capability UE may be wider compared to other UEs 104 with relatively higher capability.

In various arrangements, for frequency hopping of PRS/SRS (e.g., non-overlapping in frequency between hops), the UE 104 and/or the BS 102 can report the phase of the channel to the network (e.g., LMF 302). Additionally or alternatively, the UE 104 and/or the BS 102 can report the phase of the channel with the channel figure to the network. Additionally or alternatively, the UE 104 and/or the BS 102 can report the phase of the channel in each hop, segment, reception, or signaling together with an associated channel figure (e.g., CIR, channel frequency response (CFR)) to the network (e.g., LMF). For instance, the report from the UE 104 and/or the BS 102 to the network can include/contain the phase of the channel in each hop of the frequency hopping and the associated channel figure. In such cases, the computation of the positioning-related information may be performed/loaded on the network side (e.g., on the LMF 302), thereby reducing the resource consumption, computational complexity, or processing load on the UE 104, for example.

In some implementations, the CIR of a first arrival path may be reported by at least one of the UE 104 and/or the BS 102 to the network (e.g., 6.05e-08−6.14e-08i, −1.47e-07+1.53e-07i, 3.89e-08−4.21e-08i, 1.20e-07−1.26e-07i, −1.19e-07+1.27e-07i, etc.). Additionally or alternatively, the CIR of at least one additional path (e.g., path(s) additional to or excluding the first arrival path) can be reported. In some cases, for the channel phase in the time domain, the phase of the first arrival path (e.g., 0.3135*2π rad or 112.86 degrees) can be reported. Additionally or alternatively, the channel phase on at least one additional path can be reported. In some instances, the channel phase may be in the unit of 2π (rad) within a resolution/accuracy/precision of 0.0001. In some other instances, the phase may be in the unit of rad. In further cases, the phase may be in the unit of degree within a resolution of 0.1 degrees, for example.

In various implementations, for CFR, the CFR of one or more sub-carriers can be reported (e.g., included in the report), such as by the UE 104 and/or the BS 102 to the network. In some cases, the CFR of a center sub-carrier of a carrier may be reported. The CFR of a direct current (DC) sub-carrier of a carrier may be reported.

In some arrangements, for the channel phase on the frequency domain, the phase of the one or more sub-carriers may be reported (e.g., phase on center sub-carrier, phase on DC sub-carrier, etc.). For the channel phase, there may be a reference TRP (e.g., reference BS 102), such as a TRP with a PRS resource ID of 0. In this case, the UE 104 can report the channel phase difference relative to or associated with the reference TRP. In some arrangements, for the channel phase, there may be a reference hop, such as a hop at a specific system frame number (SFN), for instance, SFN=0 (a hop with a PRS resource ID of 0). In this case, the UE 104 can report the channel phase difference relative to the reference hop.

With the information on or related to the channel phase in each of the hops (e.g., given the phase difference between hops), the network can determine/decide whether to concatenate/combine/link/merge between at least two hops to form/generate/obtain a relatively larger/wider frequency bandwidth. Additionally or alternatively, the reported information of the channel phase can include an uncertainty (e.g., ±0.001 rad, if the signal power-to-noise ratio (SNR) is less than 0 dB). Additionally or alternatively, the information on the channel phase can indicate whether a channel (or a hop) can be concatenated to one or more channels (or hops). Additionally or alternatively, the information on the channel phase can indicate whether a channel (or a hop) can be concatenated to one or more other channels (or hops) with an indication of a level of confidence or probability (e.g., a relatively large phase difference may be associated with a relatively lower confidence level for concatenating the channels/hops to provide the desired positioning accuracy. For example, a 90% confidence can indicate that a concatenation of a hop to the previous hop (e.g., adjacent or consecutive hops) can improve the positioning accuracy (e.g., by a certain amount) in 90% of the cases when performing positioning. For instance, the level of confidence can indicate the likelihood or probability that concatenating the channels results in positioning accuracy within the desired distance (e.g., 1 meter, etc.).

In some implementations, from the perspective of the UE 104 (e.g., reduced-capability UE), a hop may be treated as a carrier. Additionally or alternatively, the UE 104 and/or the BS 102 can perform/compute a measure of a carrier phase (e.g., phase of the carrier or hop) of each carrier. The UE 104 and/or the BS 102 can report the carrier phase measurement of each carrier to the network. Additionally or alternatively, the UE 104 and/or the BS 102 can measure a carrier phase difference between at least two carriers (e.g., single difference or dual/multi differences, such as a difference between two single differences). The UE 104 and/or the BS 102 can report the measurement of the carrier phase difference to the network in response to performing the measurement. Additionally or alternatively, the carrier phase difference can be with respect to or associated with a reference carrier (e.g., reference frequency layer (FL), reference cell, reference serving cell, and/or reference point, among others). In some cases, the reference carrier may be a carrier with the lowest carrier identification (ID) (e.g., ID=0). Additionally or alternatively, the reference carrier can be a carrier with a resource ID (e.g., RS resource ID).

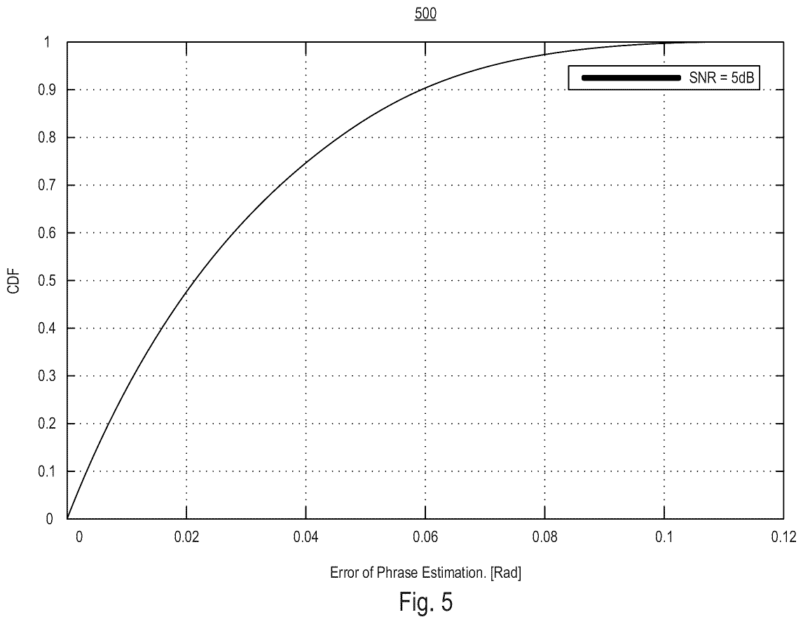

Referring to FIG. 5, an example graph 500 of phase estimation error relative to a cumulative distribution function (CDF) (e.g., probability or confidence) is depicted. As discussed herein, the accuracy of the phase can be associated with the accuracy of positioning, such that a higher phase accuracy can reflect a higher positioning accuracy. In various implementations, a phase can be computed/estimated/determined for each hop, such as by the network, the UE 104, and/or the BS 102, among other network elements. The difference between the computed phase and a real phase (e.g., a phase without any error, sometimes referred to as an actual phase, true phase, or perfect phase) may be referred to or described as a phase error. As shown, with a signal power-to-noise power ratio (SNR) of 5 dB, the phase error at 90% (e.g., 0.9) CDF can be computed as follows: 0.057/27=0.0091 radian (rad)≈1%. The relatively small phase difference/error (e.g., around 1% in this case) can be useful for positioning the UE 104. For instance, a lower phase error can correspond to higher positioning accuracy. As discussed herein, the computation of positioning-related information (e.g., including CIR, CFR, channel figure, channel phase on each hop, etc.) can be delegated/moved/transferred to the network. The positioning-related information can be used by the positioning side/end for concatenating multiple hops. The positioning side can form a larger/wider bandwidth with phase adjustment to improve the positioning accuracy of the UE 104, such as enabling the reduced-capability UE to communicate larger bandwidth/information to the network at different hops (e.g., with a minimal phase error). The wider the bandwidth of a carrier, the higher the positioning accuracy, e.g., accuracy=(bandwidth)/(speed of light).

### Example Implementation 2: PRS—Transmission with a Large/Wide Bandwidth and Reception with a Narrow Bandwidth

In various arrangements, the BS 102 (e.g., gNB, TRP, or wireless communication node) can transmit/send/provide/signal/communicate a PRS with a relatively large/wide bandwidth (e.g., 100 MHz, 110 MHz, 120 MHz, etc.) to the UE 104 via multiple transmissions (or repetitions). At the receiver of the PRS, the UE 104 can receive at least a part of the entire/whole PRS bandwidth from the BS 102, such as a relatively narrow bandwidth (e.g., 5 MHz, 20 MHz, etc., on similar or different frequencies for each reception) compared to the whole PRS bandwidth.

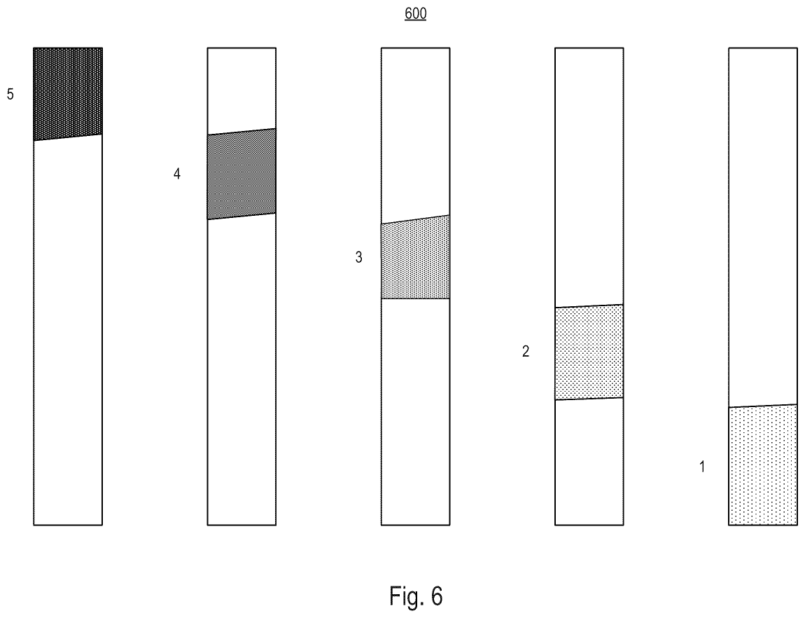

Referring to FIG. 6, depicted is an example 600 of IDs associated with parts of a positioning measurement result(s). When the UE 104 (and/or the BS 102) reports positioning measurement result(s) to the network, the UE 104 (and/or the BS 102) can tag, include, or provide identification (ID) of each part, segment, or hop of the frequency hopping. As shown in the example 600 of FIG. 6, IDs of 5, 4, 3, 2, and 1 can be tagged for the first, second, third, fourth, and fifth repetition/transmissions, respectively. In some cases, the UE 104 can report the channel figure (e.g., CIR and/or CFR) with the ID of each hop. Additionally or alternatively, the UE 104 can report the channel figure and/or the channel phase including an ID of each hop. In some cases, the order of reception and/or the order of IDs tagged for each hop may be indicated by the BS 102 and/or the LMF 302 (e.g., network). Additionally or alternatively, the ID of reception can be provided as follows:

ID=SlotNumber mod RepetitionFactor

In some implementations, the “SlotNumber” of the example reception ID can be a slot number in a radio frame. In some cases, the “SlotNumber” may be a symbol ID within a slot. The “mod” of the example reception ID can refer to a modular operation/function. The “RepetitionFactor” of the example reception ID can refer to or be a repetition factor of PRS (e.g., 5 in the case of FIG. 6). Additionally or alternatively, the “RepetitionFactor” may be provided as follows:

RepetitionFactor=ceil(BandwidthOfPRS/BandwidthOfReception)

In this case, the “ceil( . . . )” of the repetition factor can represent an operation for fetching an integer greater/larger than or equal to the operand (e.g., BandwidthOfPRS/BandwidthOfReception). The “BandwidthOfPRS” of the repetition factor can be the bandwidth of PRS (e.g., 100 MHz, etc.). The “BandwidthOfReception” of the repetition factor can be the bandwidth of reception in each hop (e.g., 20 MHz).

In some implementations, if the bandwidth of reception in each hop (e.g., 5 MHz or 20 MHz, etc.) is less than the bandwidth of PRS (e.g., 100 MHz, etc.), a comb size of PRS can be configured/set as less than a certain value, such as less than the repetition factor of PRS (e.g., 5 in the case of FIG. 6). In some other implementations, if the bandwidth of reception in each hop is less than the bandwidth of PRS, the comb size of PRS may be configured/set as greater than a certain value, such as greater than the repetition factor of PRS.

In some cases, the first hop of the frequency hopping (e.g., a hop with a hopping ID of 0) may start/initiate/restart at a specific/certain radio frame. In some other cases, the first hop (e.g., a hop with a hopping ID of 0) may start (or restart) at or with a specific SFN, such as an SFN of 0. The indication of the start or restart of the first hop of the frequency hopping can be included in the report.

In various aspects, the frequency of any two receptions (e.g., pair of receptions/communications) may be non-overlapped. In this case, the above-described phase estimation/computation can be applied for the non-overlapped frequency. In some implementations, the frequency of any two adjacent receptions may be overlapped with certain bandwidth (e.g., some RBs, some REs, and/or some sub-channel, etc.). In this case, the channel phase difference between two adjacent hops may be estimated with the overlapped bandwidth (e.g., at least one overlapped RB). In response to or subsequent to the estimation of the channel phase difference between two adjacent hops, the channel phase of a subsequent/later reception can be computed, such as by the UE 104.

Depending on the capability of the UE 104, the overlapped bandwidth can include or be one or more RBs, REs, and/or sub-carriers (SCs). The UE 104 can report its capability to the network and/or BS 102. The overlapped bandwidth can be provided as follows: BandwidthOfReception*OverlapFactor. In this case, the “OverlapFactor” may be or represent a relatively small value for overlapping (e.g., 1%). For a bandwidth of reception of 20 MHz (e.g., 100 RB at SCs of 15 kHz), the overlapped bandwidth can be one RB. In various aspects, the network can indicate the overlap factor (e.g., in the configuration information of the reference signal). Additionally or alternatively, the network can indicate the overlapped bandwidth (e.g., 2 RBs, 12 Res, 12 SCs, etc.), such as in the configuration information.

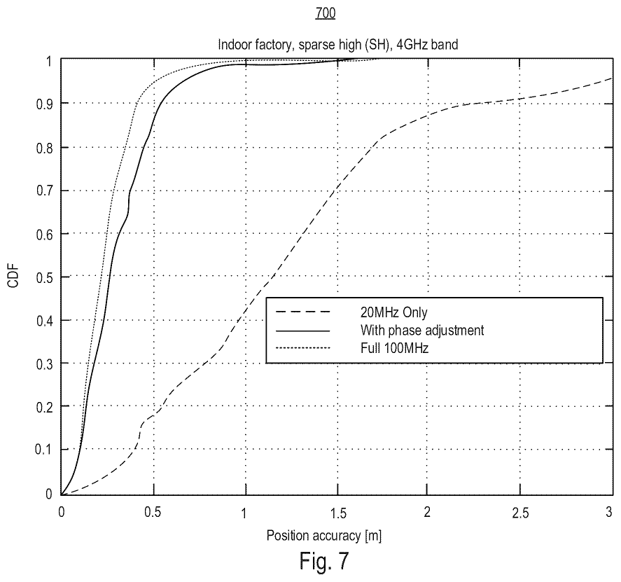

Referring to FIG. 7, depicted is an example graph 700 of positioning accuracy relative to the CDF. The example graph 700 can include a simulation of positioning accuracy performed for the reception bandwidth of a single 20 MHz, a full 100 MHz, and multiple hops with phase adjustment in a certain environment (e.g., an indoor factory). In this case, five hops with phase adjustment can be simulated in the example graph 700. As shown, the five hops with phase adjustment can improve the positioning accuracy from 2.3 meters (e.g., a single 20 MHz at 90% CDF) to 0.6 meters (e.g., multiple hops with phase adjustments at 90% CDF), thereby satisfying the desired positioning accuracy, such as under 1 meter. Hence, by performing the example operations for phase adjustment, a larger/wider/greater bandwidth with phase adjustment can be formed/generated to enhance/improve the positioning accuracy of the UE 104 (e.g., reduced-capacity UE).

### Example Implementation 3: PRS/SRS—Transmission and Reception with a Relatively Narrow Bandwidth

In various implementations, a PRS and/or SRS can be communicated (e.g., transmitted and/or received) between the UE 104 and the BS 102 with a relatively small bandwidth (e.g., 5 MHz, 20 MHz, etc., for transmission and reception). For each transmission of PRS/SRS (e.g., each hop of PRS/SRS), the frequency may be non-overlapped.

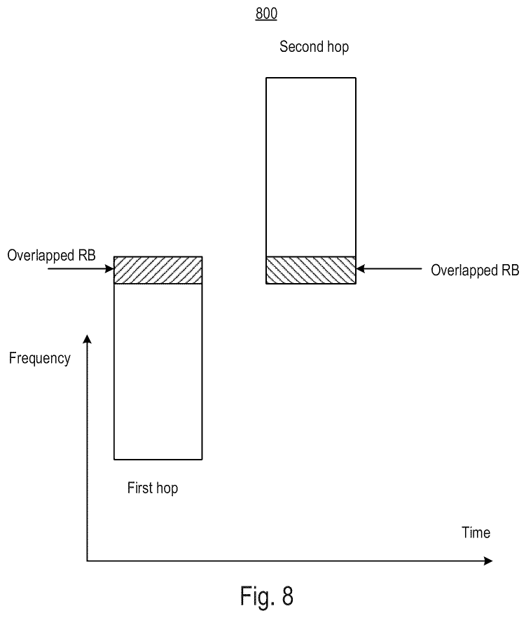

In some implementations, for two adjacent communications of PRS/SRS (e.g., two adjacent hops), some frequencies may be overlapped. FIG. 8 depicts an example of frequency overlap 800 between two adjacent transmissions of reference signals. The transmissions of PRS/SRS with frequency hopping can start with the lowest frequency (or lowest absolute radio frequency channel number (ARFCN) of a carrier. In this case, the overlapped frequency can be on the upper side (e.g., higher frequency end, such as the highest subset/portion of the frequency band shown in the first hop of FIG. 8). Additionally or alternatively, the transmissions of PRS/SRS with frequency hopping can start with the highest frequency (or highest ARFCN) of a carrier. In this case, the overlapped frequency can be on the bottom side (e.g., lower frequency end, such as the lowest portion of the frequency band shown in the second hop of FIG. 8).

For the transmissions of SRS/PRS with frequency-overlapped hopping, the number of RBs used or configured for SRS transmissions can be computed as: m_{SRS,b}+NumberOfOverlappedRB. The m_{SRS,b} can be configured by a (e.g., first) higher layer (e.g., RRC of the BS 102) for SRS transmission (e.g., for non-overlapped transmission). The “NumberOfOverlappedRB” can be configured by a (e.g., second) higher layer or the network (e.g., LMF 302, such as NumberOfOverlappedRB=1). In some cases, the parameter m_{SRS,b} can be replaced by m_{SRS,b}+NumberOfOverlappedRB for overlapped transmissions of SRS. The number of RBs can be provided/configured/included in the configuration information.

In some implementations, the configuration can include a length of SRS/PRS signal with frequency-overlapped hopping. The length can be equal to M_{SC,b}^{SRS}+NumberOfOverlappedSC. The M_{SC,b}^{SRS} can be a length of SRS and/or PRS with frequency-non-overlapped hopping. The NumberOfOverlappedSC can be a number of overlapped sub-carriers (SCs) which can be configured by a higher layer or the network.

In various cases, the length of SRS and/or PRS with frequency-overlapped hopping can be equal to or computed as M_{SC,b}^{SRS}*NumberOfHop. The M_{SC,b}^{SRS} can be the sequence length of PRS/SRS (e.g., the reference signal) for each hop without overlapping (or without hopping). The NumberOfHop can be the number of hops. Based on the M_{SC,b}^{SRS} and NumberOfHop, the network can ensure that the PRS/SRS sequence is generated as a whole (e.g., without missing hop or length of each hop).

In some implementations, for each hop of the frequency hopping, such as b=0, 1, 2, 3, . . . , bₕₒₚ−1 (e.g., for bₕₒₚ=5 and for hopping starting from the low end of the frequency), an associated frequency position index n_{b} can be equal to the following:

$${n}_{b} = \{ \begin{matrix}⌊ 4 ( {n}_{R R C} + NumberOfOverlappedRB ) / {m}_{S R S , b} ⌋ mod {N}_{b} & b \leq {b}_{hop} \\ ( {F}_{b} ( {n}_{SRS} ) + ⌊ 4 ( {n}_{R R C} + NumberOfOverlappedRB ) / {m}_{SRS , b} ⌋ ) mod {N}_{b} & otherwise\end{matrix}$$

The n_{RRC}, m_{SRS,b}, and/or N_{b} can be configured by a higher layer (e.g., of the BS 102) and/or the network. The F_{b} (n_{SRS}) can be a value associated with the reference signal (e.g., PRS/SRS) transmissions. Additionally or alternatively, for each hop of the frequency hopping (e.g., for hopping starting from at the high end of the frequency), the frequency position index n_{b} can be equal to the following:

$${n}_{b} = \{ \begin{matrix}⌊ 4 ( {n}_{R R C} + NumberOfOverlappedRB ) / {m}_{S R S , b} ⌋ mod {N}_{b} & b \leq {b}_{hop} \\ ( {F}_{b} ( {n}_{SRS} ) + ⌊ 4 ( {n}_{R R C} - NumberOfOverlappedRB ) / {m}_{SRS , b} ⌋ ) mod {N}_{b} & otherwise\end{matrix}$$

In some implementations, the UE 104 (e.g., and/or the BS 102) can determine or identify whether the frequency position index associated with at least one hop of the frequency hopping may be out of range of a bandwidth part (BWP). If the frequency position index is out of range of the BWP, the UE 104 and/or the BS 102 can restrict/cap/limit its lowest and/or highest frequency position index. In some cases, if the frequency position index is out of range of the carrier, the UE 104 and/or the BS 102 can restrict its lowest and/or highest frequency position index. In some instances, if the frequency position index is out of range of the BWP but not out of range of the carrier (e.g., within the carrier range), the UE 104 and/or the BS 102 can continue/proceed to transmit/receive PRS/SRS.

In some arrangements, the UE 104 can be triggered by a DL control information (DCI) with aperiodic SRS information (e.g., frequency resource, antenna port index, symbol index, time slot, repetition, and/or hopping) from the BS 102 and/or the network. The DCI can include at least one of an ID of the hop (e.g., from the second hop, etc.), SRS resource of the hop (e.g., RB allocation), resource set information, slot information, mapping between SRS resource and hop, etc. The resource set information can include one or more SRS resources. The control information (e.g., DL control information) can be a part of the configuration information from the network.

In some implementations, the UE 104 can request aperiodic SRS for positioning. The request can include at least one of a number of hops, ID of the hop, and/or SRS resource of a hop, among others. For each hop (except the last hop), such as b=0, 1, 2, 3, . . . , bₕₒₚ−2 (e.g., bₕₒₚ=5 and for hopping starting from the low end frequency), the frequency position index n_{b} can be equal to the following:

$${n}_{b} = \{ \begin{matrix}⌊ 4 ( {n}_{R R C} + NumberOfOverlappedRB ) / {m}_{S R S , b} ⌋ mod {N}_{b} & b \leq {b}_{hop} \\ ( {F}_{b} ( {n}_{SRS} ) + ⌊ 4 ( {n}_{R R C} + NumberOfOverlappedRB ) / {m}_{SRS , b} ⌋ ) mod {N}_{b} & otherwise\end{matrix}$$

The n_{RRC}, m_{SRS,b}, and/or N_{b} can be configured by higher layer or the network. The F_{b}(n_{SRS}) can depend on or be based on RS transmissions. The last hop (or the first hop in some cases) can follow the non-overlapped process/operation/technique, for instance, by setting NumberOfOverlappedRB=0.

In some implementations, for each hop except/excluding the first hop, such as b=1, 2, 3, . . . , bₕₒₚ−1 (e.g., bₕₒₚ=5 and for hopping starting from the high end frequency), the frequency position index n_{b} can be equal to the following:

$${n}_{b} = \{ \begin{matrix}⌊ 4 ( {n}_{R R C} + NumberOfOverlappedRB ) / {m}_{S R S , b} ⌋ mod {N}_{b} & b \leq {b}_{hop} \\ ( {F}_{b} ( {n}_{SRS} ) + ⌊ 4 ( {n}_{R R C} - NumberOfOverlappedRB ) / {m}_{SRS , b} ⌋ ) mod {N}_{b} & otherwise\end{matrix}$$

Additionally or alternatively, at least two adjacent/consecutive hops of PRS/SRS may be contiguous in frequency (e.g., continuous in frequency). The frequency between the least two adjacent hops can form a contiguous larger bandwidth (e.g., aggregated or combined frequencies). In this case, there may be no frequency separation between the at least two adjacent hops.

In various arrangements, the UE 104 can indicate to the BS 102 at least one hop or segment of SRS to be transmitted by the UE 104 at a later time instance. In some other arrangements, the BS 102 can indicate to the UE 104 at least one hop or segment of PRS to be transmitted by the BS 102 at a later time instance.

In some implementations, the BS 102 and/or the network can configure one or more patterns for the transmission of PRS/SRS (e.g., with multiple hops). The BS 102 and/or the network can indicate the pattern(s) to be used for the subsequent PRS/SRS transmission(s) (e.g., via the DCI). In some cases, for overlapped transmission of PRS/SRS, the pattern(s) can be sub-set(s) of non-overlapped transmission of PRS/SRS. In some cases, the pattern(s) may be configured by the high layer (e.g., via system information block (SIB)).

In various implementations, the sequence r(m) used for PRS/SRS can be as follows:

$$r ( m ) = \frac{1}{\sqrt{2}} ( 1 - 2 c ( 2 m ) ) + j \frac{1}{\sqrt{2}} ( 1 - 2 c ( 2 m + 1 ) )$$

A pseudo-random sequence generator configured to generate the pseudo-random sequence c(i) to generate the reference signal (e.g., PRS/SRS) can be initialized/started/executed based on or with the following:

$${c}_{i n i t} = ( {2}^{22} ⌊ \frac{{n}_{ID , seq}^{PRS}}{1024} ⌋ + {2}^{10} ( {N}_{symb}^{slot} {n}_{s , f}^{μ} + l + 1 ) ( 2 ( {n}_{ID , seq}^{PRS} mod 1024 ) + 1 ) + ( {n}_{ID , s e q}^{PRS} mod 1024 ) + HopID ) mod {2}^{31}$$

The n_{s,f}^{μ} can be the slot number. The sequence ID n_{ID,seq}^{PRS}∈{0, 1, . . . , 4095, 4096, 4097, . . . , 8191} can be configured by higher layer. The l can represent a symbol index within the slot. The Nsymob can correspond to a number of symbols in a slot (e.g., 12 or 14, etc.). The HopID can be the hopping ID of PRS/SRS (e.g., 0, 1, 2, 3, 4, etc., for overlapped transmission). In various implementations, the generator (e.g., pseudo-random sequence generator) can be included as part of the configuration information from the BS 102 and/or the network.

In certain implementations, the total length m of PRS/SRS sequence of one or more hops can be equal to m=NumberOfRB*NumberOfHop. The NumberOfRB can represent or correspond to the number of RBs for each hop without overlapping. The NumberOfHop can correspond to the number of hops. Based on the total length m, the PRS/SRS sequence can be generated as a whole by the UE 104 and/or the BS 102. The total length may be included/provided/indicated as part of the configuration information.

In some cases, the generator for generating the pseudo-random sequence c(i) can be initialized based on the following:

$${c}_{i n i t} = ( {2}^{23} ⌊ \frac{{n}_{ID , seq}^{PRS}}{2048} ⌋ + {2}^{10} ( {N}_{symb}^{slot} {n}_{s , f}^{μ} + l + 1 ) ( 2 ( {n}_{ID , seq}^{PRS} mod 2048 ) + 1 ) + ( {n}_{ID , s e q}^{PRS} mod 2048 ) + HopID ) mod {2}^{31} ,$$

$$or$$

$${c}_{i n i t} = ( {2}^{23} ⌊ \frac{{n}_{ID , seq}^{PRS}}{2048} ⌋ + {2}^{11} ( {N}_{symb}^{slot} {n}_{s , f}^{μ} + l + 1 ) ( 2 ( {n}_{ID , seq}^{PRS} mod 2048 ) + 1 ) + ( {n}_{ID , s e q}^{PRS} mod 2048 ) + HopID ) mod {2}^{31}$$

Additionally or alternatively, the bandwidth (e.g., in number of RBs) of PRS/SRS can be included as part of the configuration information. The bandwidth can be equal to n_{RRC}+| NumberOfOverlappedRB. The n_{RRC} can represent the bandwidth (e.g., in number of RBs) of PRS/SRS with non-overlapped transmission, non-hopping transmission, and/or normal transmission. The NumberOfOverlappedRB can be configured by the high layer. In some cases, for the first hop and/or the last hop, depending on the starting direction of the hop(s) (e.g., from the high frequency end or the low frequency end), of PRS/SRS with overlapped transmission, the NumberOfOverlappedRB can be set 0.

In some arrangements, the configuration information can include or indicate a comb size of PRS/SRS. The comb size of PRS/SRS (e.g., reference signal) can be configured as one or three, among other values. In this configuration/setting, the measurement delays and/or buffer size of the signal for reference signal measurement can be reduced for multiple hops. For example, with the comb size of one, the PRS/SRS may start transmission at sub-carrier 0 in each RB. In another example, with a comb size of three, the PRS/SRS may start transmission at sub-carrier 0, 1, and 2 for symbol index SymbolIndex mod 3 in each RB.

In some implementations, for PRS/SRS transmission with hopping, the BS 102 and/or the network can mute/disregard one or more PRS/SRS hops, e.g., to mitigate interference from neighboring cells for a good reception from the UE 104. A bitmap can be used to indicate whether a particular ho is muted. For instance, a bitmap with a value of “1” can indicate that the hop is muted, or vice versa, depending on the configuration.

For reduced-capability UE, the total measurement delay can be relaxed or less restricted. For example, the configuration information can indicate that for reduced-capability UE, the total measurement delay can be relaxed with the number of hops. The total measurement delay can be relaxed to MeasureDelayNormal*NumberOfHop. The MeasureDelayNormal can be a measurement delay for a relatively normal UE (e.g., predefined by in the configuration information). In some cases, the MeasureDelayNormal can be a measurement delay for a single hop. The NumberOfHop can be a value configured by the high layer and/or the network.

In certain arrangements, the measurement period (e.g., duration) can be relaxed for the reduced-capability UE. Additionally or alternatively, the effective processing period/time/duration (Teff) can be associated with the number hops (H) (e.g., computed as Teff=H*TOneHop). In some cases, the effective processing period can be associated with a total bandwidth or effective bandwidth (e.g., a bandwidth after multiple hops, such as 5 hops with 20 MHz each which is equal to 5*20=100 MHz). The effective bandwidth can depend or be based on the UE capability reported by the UE 104 to the network.

The effective processing period can be associated with a gap between hops (e.g., at least one gap in time slot). For example, the effective processing period can be computed as follows: Teff=H*(TOneHop+Gap) or Teff=H*TOneHop+(H−1)*Gap. The Gap can correspond to the duration between hops. If the time gaps between hops are different, the total gap duration may be applied, such as Teff=H*TOneHop+TotalGap.

In some implementations, the relaxed measurement delay may be configured to not exceed (e.g., capped/limited/restricted) at a certain value, such as MeasureDelayNormal*min(5, NumberOfHop), for example.

In some arrangements, a positioning process window (PPW) or measurement gap (MG) for the UE 104 (e.g., reduced-capability UE) can be related to or associated with the number of hops capable of being supported by the UE 104. The UE 104 can report its capability including/regarding the number of hops supported by the UE 104. The PPW configured for the reduced-capability UE can be NormalPPW*NumberOfHop. The NormalPPW can be the PPW for a relatively normal UE (e.g., non-reduced-capability UE). In some cases, the PPW configured for the reduced-capability UE can be NormalPPW*min(3, NumberOfHop). The PPW can be included in the report.

In some instances, the number of paths for measurement (e.g., reference signal received path power (RSPP)) for the reduced-capability UE can be reduced or relaxed (e.g., ½, ¼, ⅛, or 1/NumberOfHop). In certain cases, a single path with the best channel quality (e.g., the path with the highest RSRP) may be reported for the reduced-capability UE. The number of paths for measurement can be included in the report.

In some implementations, for PRS/SRS hopping, there may be a hopping application delay (e.g., 2 slots, 4 slots, etc., as different numerology has a different duration of a slot). The delay can ensure stable/consistent transmission of signals after radio frequency (RF) re-tuning, among other conditions. For each PRS/SRS hop, the UE 104 and/or the BS 102 can indicate the transmission phase to the other. For each PRS/SRS hop, the phase may be set/configured/indicated (e.g., 0, π/2, π, and/or 3π/2 for the first, second, third, and/or fourth hop).

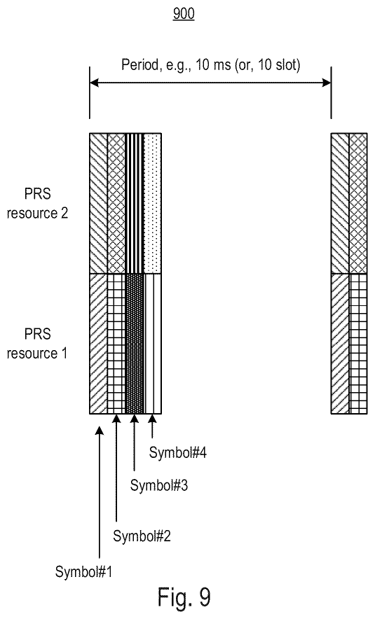

In some cases, a PRS/SRS pattern (e.g., period, repeat, or hop) may be configured for a reduced-capability UE, such as in the configuration information from the BS 102 and/or the network. Referring to FIG. 9, depicted is an example of a reference signal pattern 900. Although the PRS pattern is shown, the SRS pattern may be described or shown similarly to the PRS pattern of FIG. 9. For example, the PRS pattern can include a period of 10 slots, a repetition factor of 4 symbols (e.g., symbol #1, 2, 3, and 4), two resources (on different frequencies, contiguous or discontiguous), and/or two hops. For example, with the PRS pattern, the UE 104 can measure the first PRS resource on symbol #1, and/or report the measured first PRS resource to the network. Subsequently, the UE 104 can measure and/or report the measurement of the second PRS resource on symbol #3. Further, the UE 104 can measure and report the measurement of the concatenated signal of the first PRS resource on symbol #1 and the second PRS resource on symbol #3. In some cases, the report can include a symbol ID. In some aspects, the report can include a combination of at least a resource ID and symbol ID. In some cases, the report can include a combination of at least resource ID, symbol ID, and concatenation state. In certain cases, the report can include a hop ID.

In some implementations, the same PRS/SRS pattern can be configured for the UE 104 in different serving cells or serving TRP/BS 102/gNB (e.g., two neighboring BSs 102) with muting. For example, the symbol #1 and symbol #3 may be for a certain UE in communication with a first BS (e.g., in a first cell), while the symbol #1 and symbol #3 are muted for another UE in communication with a second BS (e.g., in a second cell). In this case, the symbol #2 and symbol #4 may be muted for the certain UE in the first cell, while being available for the other UE in the second cell. Given the muting of various signals/symbols, the (e.g., positioning) measurement of the UE 104 may not be interfered by one or more neighboring BSs 102. Hence, using the PRS/SRS pattern(s), the receiver (e.g., BS 102 and/or network) can form a larger bandwidth with phase adjustment provided with the relatively narrower bandwidth, thereby improving the positioning of the UE 104.

### Example Implementation 4: Other Signals for Positioning

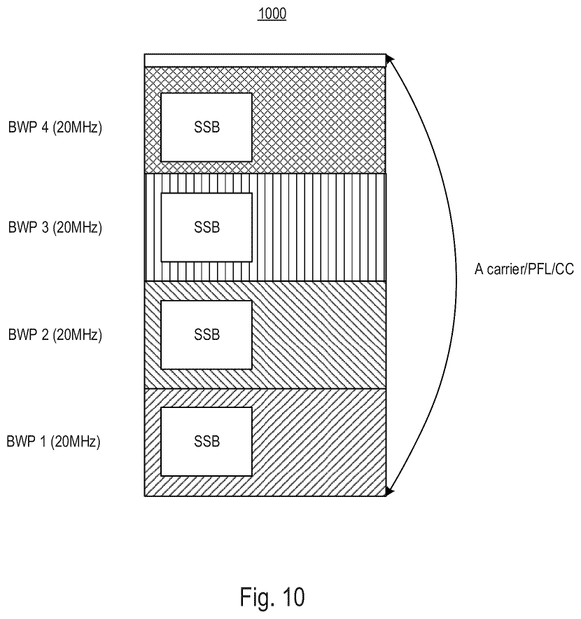

In various arrangements, other signals (e.g., synchronization signal block (SSB), channel-state information reference signal (CSI-RS), tracking reference signal (TRS), SRS-multiple-input/multiple-output (MIMO), etc.) may be used for positioning the UE 104. Referring to FIG. 10, an example of a carrier having several BWPs is depicted. For instance, a carrier (e.g., positioning frequency layer (PFL), component carrier (CC), etc.) for the UE 104 can have several BWPs. Each BWP can include at least one SSB. In this case, four BWPs of the carrier having respective SSBs can be shown in FIG. 10.

In some implementations, the UE 104 can receive multiple SSBs on different BWPs (or carrier, different BWPs on different carriers, etc.). The UE 104 may receive multiple CSI-RSs or TRSs (e.g., a subset of CSI-RS) on different BWPs (or carrier, different BWP on different carrier, etc.). The UE 104 can concatenate multiple SSB (e.g., and/or CSI-RS and/or TRS) on different frequencies, BWPs, and/or carrier to form a relatively larger bandwidth. The UE 104 can perform positioning-related measurement(s) and provide report(s) on concatenated SSBs, CSI-RS, or TRS. In some implementations, the UE 104 can measure and/or report TOA, TDOA, round trip time (RTT), carrier phase, receiving power, receiving path power related, among other positioning-related information measured based on concatenated multiple SSBs, CSI-RS, and/or TRS. The SSB ID/BWP ID/carrier ID may be tagged when the measurement result(s) is/are reported to the network.

In various aspects, the UE 104 can report its capability regarding its support of concatenated multiple SSBs, CSI-RS, and/or TRS. In some cases, the UE 104 may report its capability to support one or multiple SSBs, CSI-RS, and/or TRS, which may include a buffer capability (e.g., to store multiple signals) of the UE 104. The UE 104 may measure and/or report the TOA/TDOA/RTT/carrier phase/receiving power/receiving path power related positioning information, among other position-related information measured based on one or multiple SSB (or CSI-RS, or TRS).

In various implementations, the UE 104 can transmit/send/provide SRS with multiple antennas (e.g., SRS-MIMO, such as from the reduced-capability UE on frequency range 2 (FR2)). The UE 104 can be configured to transmit SRS with multiple antennas, where each antenna (e.g., antenna port) can be associated with an SRS resource or SRS resource set. Additionally or alternatively, at least one antenna (or antenna port) may be associated with an SRS resource (or SRS resource set). In some cases, different SRS resource (or SRS resource set) may be communicated via different frequencies (e.g., on different BWPs, different carriers, etc.).

In some arrangements, the BS 102 (e.g., gNB or TRP) may receive SRS-MIMO with different SRS resources (or SRS resource sets) from different UE antennas (or antenna ports). The BS 102 may concatenate different SRS signals to form/generate a large bandwidth (e.g., combined/concatenated/merged bandwidth/SRS signal). The BS 102 may measure and/or report the positioning-related measurement(s) on the concatenated SRS signal. In some cases, the BS 102 can measure and/or report TOA/TDOA/round trip time (RTT)/multiple-RTT/carrier phase/receiving power/receiving path power related positioning information, etc. on the concatenated SRS signal to the network.

In various cases, the reduced-capability UE (e.g., wearable device or smartwatch, among other devices with reduced capability compared to a reference device considered as “normal” device) may be power sensitive. In these cases, the network (e.g., LMF 302) can indicate/provide/signal to the reduced-capability UE to skip/ignore reception of PRS (and/or transmission SRS for positioning) during a time period/duration outside active time (e.g., discontinue reception off (DRX-OFF) or DRX-OFF before receiving paging related information, etc.).

In some implementations, for the UE 104 under RRC idle/inactive state, the UE 104 may receive the PRS during DRX-ON (e.g., when receiving paging-related information). In this case, the UE 104 may skip receiving PRS during the DRX-OFF (e.g., outside active time) during RRC idle/inactive/connected state. Additionally or alternatively, the UE 104 may skip transmission SRS during DRX-OFF (e.g., outside active time) during RRC idle/inactive/connected state.

In various implementations, the UE 104 may be equipped/configured/embedded with two physical antennas and one RF channel (or RF chain). In this case, the UE 104 can communicate the reference signal (e.g., receive PRS and/or transmit SRS) with one physical antenna at a certain time instance (e.g., on odd symbols) and with another physical antenna at another time instance (e.g., on even symbols). Based on this configuration for the UE 104, the UE 104 can measure the angle of arrival (AoA), and/or carrier phase (or carrier phase difference between two antennas) of PRS. Additionally or alternatively, the BS 102 can measure an angle of departure (AoD), and/or carrier phase (or carrier phase difference between two antennas) of SRS from the UE 104 in this case.

In some cases, the network or the BS 102 can configure different PRS/SRS resources (or resource sets) for different antennas. The UE 104 can report the AoA, and/or carrier phase (or carrier phase difference between two antennas) to the LMF 302 (e.g., network) with at least the PRS resource ID (or resource set ID). Additionally or alternatively, the BS 102 can report the AoD, and/or carrier phase (or carrier phase difference between two antennas) to the network with at least the SRS resource ID (or resource set ID). Based on the concatenation of symbols or signals discussed herein, the UE 104 and/or the BS 102 can generate/form a larger bandwidth with signal(s) different from the PRS/SRS, thereby improving the accuracy of positioning.

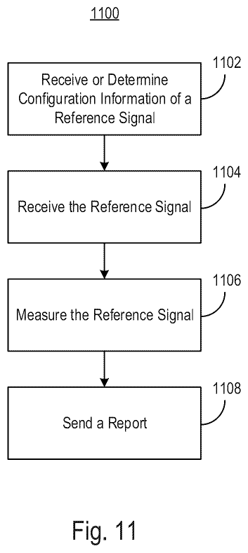

FIG. 11, is a flow diagram illustrating an example method 1100 for low-capability UE positioning. Referring to FIG. 11, the method 1100 can be performed by one or more network elements (e.g., at least one UE 104, at least one BS 102/TRP, and/or at least one LMF 302/CN). In some arrangements, at 1102, the method 1100 can include receiving or determining configuration information of a reference signal. The method 1100 can include receiving the reference signal, at 1104. The method 1100 can include measuring the reference signal, at 1106. The method 1100 can include sending a report, at 1108.

Still referring to FIG. 11, and in further details, at 1102, a UE (e.g., wireless communication device) can receive the configuration information of the reference signal (e.g., PRS/SRS) from a network (e.g., LMF or CN) and/or a BS (e.g., wireless communication node, gNB, or TRP) can determine the configuration information of the reference signal. The configuration information can include information associated with frequency hopping of the reference signal.

In various implementations, the configuration information can indicate/provide an overlap factor. The overlap factor can be used to estimate/determine the correct phase of the channel to remove the random phase of each hop. In some implementations, the configuration information can indicate an overlapped bandwidth. In some implementations, the configuration information can include a number of Resource Blocks (RBs) configured for transmitting the reference signal. The number of RBs may be equal to m_{SRS,b}+NumberOfOverlappedRB. The m_{SRS,b} can be configured by a first higher layer for transmitting the reference signal and the NumberOfOverlappedRB may be configured by a second higher layer for transmitting the reference signal. In some cases, at least one of the overlap factor, overlapped bandwidth, and/or the number of RBs may be used to estimate the correct phase of the channel for removing the random phase of each hop, for example.

In some implementations, the configuration information can include a length of the reference signal with frequency-overlapped hopping. The length may be equal to M_{SC,b}^{SRS}+NumberOfOverlappedSC. The M_{SC,b}^{SRS} may be a length of the reference signal with frequency-non-overlapped hopping and the NumberOfOverlappedSC may be a number of overlapped sub-carriers which is configured by a higher layer or the network.

In some implementations, the configuration information can include a length of the reference signal with frequency-overlapped hopping, wherein the length is equal to M_{SC,b}^{SRS}*NumberOfHop. In this case, the M_{SC,b}^{SRS} can be a sequence length of the reference signal for each hop of the frequency hopping without overlapping and the NumberOfHop may be a number of hops. The length of the reference signal with frequency-overlapped hopping may be used for removing the random phase of each hop, in certain cases.

In some implementations, for each hop of the frequency hopping, the configuration information can include an associated frequency position index n_{b}, which can be equal to the following:

$${n}_{b} = \{ \begin{matrix}⌊ 4 ( {n}_{R R C} + NumberOfOverlappedRB ) / {m}_{S R S , b} ⌋ mod {N}_{b} & b \leq {b}_{hop} \\ ( {F}_{b} ( {n}_{SRS} ) + ⌊ 4 ( {n}_{RRC} + NumberOfOverlappedRB ) / {m}_{SRS , b} ⌋ ) mod {N}_{b} & otherwise\end{matrix}$$

The n_{RRC}, m_{SRS,b}, N_{b} can each be configured by a higher layer or the network. The F_{b}(n_{SRS}) may be a value associated with the transmission of the reference signal. The frequency position index can be used to form/generated/determine the sequence of each hop as a whole, such as to reject potential interference from other network entities/elements.

In some implementations, for each hop of the frequency hopping, the configuration information can include an associated frequency position index n_{b}, which can be equal to:

$${n}_{b} = \{ \begin{matrix}⌊ 4 ( {n}_{R R C} - NumberOfOverlappedRB ) / {m}_{S R S , b} ⌋ mod {N}_{b} & b \leq {b}_{hop} \\ ( {F}_{b} ( {n}_{SRS} ) + ⌊ 4 ( {n}_{R R C} - NumberOfOverlappedRB ) / {m}_{SRS , b} ⌋ ) mod {N}_{b} & otherwise\end{matrix}$$

The n_{RRC}, m_{SRS,b}, N_{b} can each be configured by a higher layer or the network. The F_{b}(n_{SRS}) may be a value associated with the transmission of the reference signal.

In various implementations, the configuration information may include a generator. The generator can be configured to generate a pseudo-random sequence (e.g., Cᵢₙᵢₜ) to generate the reference signal and/or obtaining/getting a correct hopping ID. The generator can be initialized/started based on the following:

$${c}_{i n i t} = ( {2}^{22} ⌊ \frac{{n}_{ID , seq}^{PRS}}{1024} ⌋ + {2}^{10} ( {N}_{symb}^{slot} {n}_{s , f}^{μ} + l + 1 ) ( 2 ( {n}_{ID , seq}^{PRS} mod 1024 ) + 1 ) + ( {n}_{ID , s e q}^{PRS} mod 1024 ) + HopID ) mod {2}^{31}$$

The n_{s,f}^{μ} may be a slot number. The sequence ID n_{ID,seq}^{PRS}∈{0, 1, . . . , 4095, 4096, 4097, . . . , 8191} may be configured by a higher layer. The l can be a symbol index within a slot. The N_{symb}^{slot} can be a number of symbols in a slot. The HopID can be a hopping ID of the reference signal. In some implementations, the configuration information can include a total length m of a sequence of all hops of the frequency hopping. The total length can be used for forming a sequence of each hop as a whole, thereby avoiding/rejecting possible interference. The m can be equal to NumberOfRB*NumberOfHop. The NumberOfRB can correspond to a number of RB for each of the hops without overlapping. The NumberOfHop can correspond to a number of the hops.

In some implementations, the configuration information can include a bandwidth of the reference signal, for instance, to generate overlapped resource for each hop. The bandwidth may be equal to n_{RRC}+NumberOfOverlappedRB. The n_{RRC} may be a bandwidth with non-overlapped transmission. The NumberOfOverlappedRB may be configured by a high layer. In some implementations, the configuration information can indicate that a comb size of the reference signal can be configured as one or three for reducing processing delay, such as for the UE and/or the BS. In some implementations, the configuration information can indicate that when the UE is a RedCap UE, a total measurement delay is relaxed with number of hops (e.g., the total measurement delay is relaed to the number of hops).

At 1104, the UE and/or the BS can receive/obtain/acquire the reference signal (e.g., PRS and/or SRS, respectively). In this case, the UE can receive the PRS from the BS, and/or the BS can receive the SRS from the UE. In some implementations, the UE and/or the BS can determine that a frequency position index associated with a hop of the frequency hopping is out of range of a bandwidth part (BWP) but not out of range of a carrier. In response to the determination, the UE and/or the BS can continue receiving the reference signal, for instance, to generate an overlapped resource for each hop.

At 1106, the UE and/or the BS can measure the respective reference signal. For instance, the UE can measure the PRS, and/or the BS can measure the SRS. In response to obtaining/determining the measurement, the UE and/or the BS can generate a report including at least a measurement result of the reference signal, respectively.

At 1108, the UE and/or the BS can send/transmit/signal/communicate/provide the report to the network. In some implementations, the report can include a phase of a channel in each hop of the frequency hopping and/or an associated channel figure. In this case, the computation of positioning-related information may be performed on the network. The positioning side can form a larger bandwidth with phase adjustment to improve the positioning accuracy (e.g., wider bandwidth).

In some implementations, the report can include a carrier phase difference with respect to a reference carrier. A differential operation (e.g., carrier phase difference) can be performed to remove phase error.

In some implementations, the report can include an identification (ID) of each hop of the frequency hopping. Based on the ID of each hop, the positioning end (e.g., network) can determine the hops (e.g., on different frequencies) that are concatenated. In some implementations, the report can indicate that a first hop of the frequency hopping starts, and/or restarts, with a specific system frame number, such as for determining the concatenation between two hops on a time boundary. In some cases, at least one pair of hops (e.g., adjacent hops) may not be concatenated based on the time boundary. For example, the signal may be counted/measured by time block (e.g., 1024*10 ms=10.24 seconds). After one time block, the signal may be re-counted (e.g., the cᵢₙᵢₜ may be affected because of the n_{s,f}^{μ}, the time slot number can be re-counted/restarted). In this case, a hop before a time block and a hop after the time block may not be concatenated, for example. In some implementations, the report can include a positioning process window (PPW) configured for a reduced-capability (RedCap) UE. The PPW can be NormalPPW*NumberOfHop. The NormalPPW can represent or correspond to the PPW for a relatively normal UE.

In some implementations, the report can include a number of paths for measurement for a RedCap UE being relaxed. In some implementations, the report can include positioning-related information measured based on multiple Synchronization Signal Blocks (SSBs). In some cases, this positioning-related information can be used to reduce system complexity, e.g., for the UE and/or the BS.

In some implementations, the report can include a capability of the UE to support measurement on multiple SSBs. In some implementations, for reporting by the BS, for example, the report can include measurements on one or more concatenated Sounding Reference Signals (SRSs).

While various arrangements of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of some arrangements can be combined with one or more features of another arrangement described herein. Thus, the breadth and scope of the present disclosure should not be limited by any of the above-described illustrative arrangements.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method for positioning, comprising:
receiving, by a user equipment (UE) from a network, configuration information of a reference signal for positioning, wherein the configuration information comprises information associated with frequency hopping of the reference signal;
receiving, by the UE, the reference signal;
measuring, by the UE, the reference signal; and
sending, by the UE to the network, a report comprising a measurement result of the reference signal.

2. The wireless communication method according to claim 1, wherein the information is based on a single hop or multiple hops of the frequency hopping.

3. The wireless communication method according to claim 1, wherein the configuration information indicates at least one of: an overlapped bandwidth, a number of overlapped resource blocks (RBs), or a number of hops.

4. The wireless communication method according to claim 1, wherein the report includes at least one of: a timestamp or a carrier phase measurement.

5. The wireless communication method according to claim 1, wherein the report includes a symbol identifier (ID).

6. A user equipment (UE), comprising:
at least one processor configured to:
receive, via a transceiver from a network, configuration information of a reference signal for positioning, wherein the configuration information comprises information associated with frequency hopping of the reference signal;
receive, via the transceiver, the reference signal;
measure, by the UE, the reference signal; and
send, via the transceiver to the network, a report comprising a measurement result of the reference signal.

7. The UE according to claim 6, wherein the information is based on a single hop or multiple hops of the frequency hopping.

8. The UE according to claim 6, wherein the configuration information indicates at least one of: an overlapped bandwidth, a number of overlapped resource blocks (RBs), or a number of hops.

9. The UE according to claim 6, wherein the report includes at least one of: a timestamp or a carrier phase measurement.

10. The UE according to claim 6, wherein the report includes a symbol identifier (ID).

11. A wireless communication method for positioning, comprising:
determining, by a network, configuration information of a reference signal for positioning, wherein the configuration information comprises information associated with frequency hopping of the reference signal; and
receiving, by the network from a user equipment (UE), a report comprising a measurement result of the reference signal.

12. The wireless communication method according to claim 11, wherein the information is based on a single hop or multiple hops of the frequency hopping.

13. The wireless communication method according to claim 11, wherein the configuration information indicates at least one of: an overlapped bandwidth, a number of overlapped resource blocks (RBs), or a number of hops.

14. The wireless communication method according to claim 11, wherein the report includes at least one of: a timestamp or a carrier phase measurement.

15. The wireless communication method according to claim 11, wherein the report includes a symbol identifier (ID).

16. A network, comprising:
at least one processor configured to:
determine configuration information of a reference signal for positioning, wherein the configuration information comprises information associated with frequency hopping of the reference signal; and
receive, via a transceiver from a user equipment (UE), a report comprising a measurement result of the reference signal.

17. The network according to claim 16, wherein the information is based on a single hop or multiple hops of the frequency hopping.

18. The network according to claim 16, wherein the configuration information indicates at least one of: an overlapped bandwidth, a number of overlapped resource blocks (RBs), or a number of hops.

19. The network according to claim 16, wherein the report includes at least one of: a timestamp or a carrier phase measurement.

20. The network according to claim 16, wherein the report includes a symbol identifier (ID).
